(19) United States
(12) Patent Application Publication
(10) Pub. No.: US 2008/0117303 A1
(43) Pub. Date: May 22, 2008

(54) CAMERA WITH SHAKE DETECTING FUNCTION

(75) Inventor: Hiroyuki FURUMOCHI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/943,675

(22) Filed: Nov. 21, 2007

(30) Foreign Application Priority Data
Nov. 22, 2006 (JP) 2006-315487

(51) Int. Cl. H04N 5/228

(52) U.S. Cl. 348/208.2; 348/E05.024

(57) ABSTRACT

A camera has a shake detector, a main power source controller, and a photograph controller. The shake detector is capable of detecting a shake while a main power source is in the OFF state. The main power source controller turns the main power source on when a shake is detected while tho main power source is in the OFF state. Then, the photograph controller carries out a photographing process when the main power source is turned on by the detection of the shake.

### BACKGROUND OF THE INVENTION

1. Field of the Invention

The present invention relates to a camera capable of detecting that it is being shaken. In particular, it relates to a photograph taken under a special circumstance such as an earthquake.

2. Description of the Related Art

In a digital compact camera or an SLR camera with image-blur compensating function, camera shake due to the operator's hand movement is detected by a gyro sensor or the movement of the image. When shake is detected during a photographing operation, an optical lens or an image sensor is shifted so as to compensate for the camera shake, so that an image free of blur may be obtained.

A broadcast station may be known to place video cameras at various locations, such as building tops, to capture a disaster scene. A centralized broadcast station continuously monitors video images sent from the cameras. A broadcast system is capable of detecting a disaster scene automatically and instantly, wherein an earthquake is detected by a movement-vector of the video image. Then, the centralized broadcast station discriminates the video image photographed by the camera located in the earthquake area, from among a number of images captured by a number of video cameras.

However, the setting position of the cameras and the number of settable cameras may be limited. For example, many broad cameras cannot be placed in private homes. Therefore, photographing a scene instantly in a place where a violent disaster actually occurs may be difficult.

### SUMMARY OF THE INVENTION

An object of the present invention is to provide a camera and an imaging device that is capable of reliably photographing a scene using a simple construction when an emergency situation such as an earthquake occurs.

A camera according to the present invention has a shake detector, a main power-source controller, and a photograph controller. The shake detector is capable of detecting a shake while the main power source is off. The main power source supplies electric power to circuits, actuators, and so on, so as to allow a photographing process to be carried out. The shake detector detects a shake by an electric power supply different from the main power source. The main power source controller turns the main power-source on when a shake is detected while the main power source is in off. Then, the photograph controller carries out a photographing process when the main power source has been turned on by the detection of the shake.

An apparatus for photographing a subject, according to another aspect of the present invention, has a shake detector and a photograph controller. The shake detector is capable of detecting a shake while the photographing process is not carried out. The photograph controller carries out a photographing process for recording a still image and/or a moving image in response to the detection of the shake.

A computer-readable medium that stores a program for photographing a subject, according to another aspect of the present invention, has a shake detection code segment that detects whether a shake occurs while the photographing process is not carried out; and a photograph control code segment that carries out the photographing process for recording a still image and/or a moving image when a shake is detected.

A method for photographing a subject, according to another aspect of the present invention, includes: a) detecting whether a shake occurs while the photographing process is not carried out; and b) carrying out the photographing process for recording a still image and/or a moving image when a shake is detected.

### BRIEF DESCRIPTION OF THE DRAWINGS

The present invention will be better understood from the description of the preferred embodiments of the invention set forth below together with the accompanying drawings, in which:

FIG. 1 is as schematic perspective view of a digital camera according to the present embodiment;

FIG. 2 is a front view of the digital camera;

FIG. 3 is a block diagram of the camera;

FIG. 4 is a view showing a flowchart of an electric power control process performed by an auxiliary CPU; and

FIG. 5 is a view showing a flowchart of a photographing process for emergencies.

### DESCRIPTION OF THE PREFERRED EMBODIMENTS

Hereinafter, the preferred embodiment of the present invention is described with reference to the attached drawings.

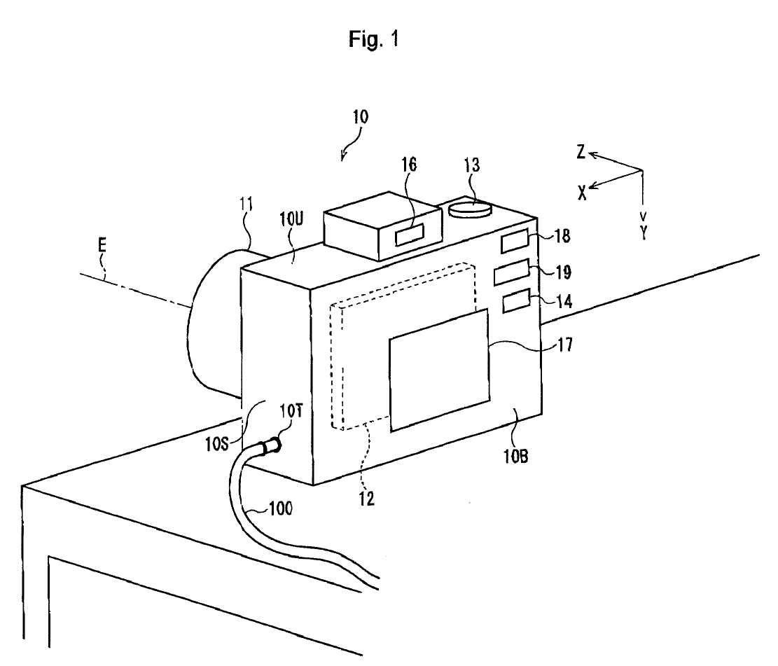

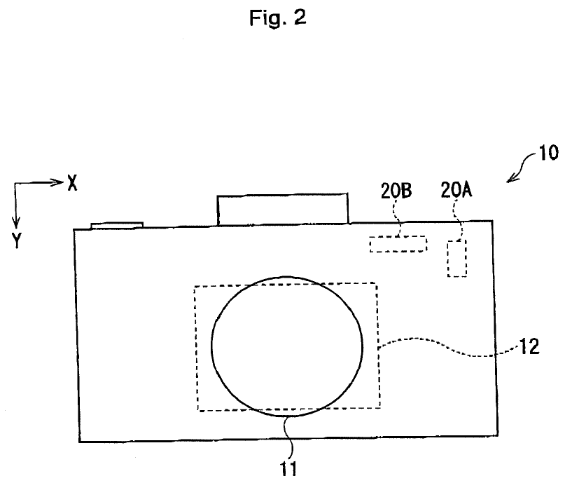

FIG. 1 is a schematic perspective view of a digital camera according to the present embodiment. FIG. 2 is a front view of the digital camera.

The digital camera 10 is equipped with an image-blur compensating mechanism 12 at the rear of a lens barrel 11. A release button 13 and an image-blur compensating button 16 are provided on the upper surface 10U of the camera 10, while a mode-setting button 14, an LCD monitor 17, a main power button 18, and an emergency photograph setting button 19 are provided on the back surface 10B of the camera 10. A zoom lens (not shown) is included in a photographing optical system (not shown) provided in the lens barrel 11. A zoom lever for shifting the zoom lens is provided on the back surface 10B (not shown).

The camera 10 is capable of photographing a scene while the main electric power source is off. When the emergency-photograph setting button 19 is set by a user, the camera 10 is capable of instantly photographing a scene when an emergency situation such as an earthquake occurs. As shown in FIG. 1, in order to support the camera 10 securely, it may be placed on a flat table in any ordinary home, with the main power source in the off state. In addition, an AC adapter 100 with a cord is inserted into a socket 10T provided on the side surface 10S of the camera 10, to supply electric power securely during the OFF state of the main electric power.

As shown in FIG. 2, a first gyro sensor 20A and a second gyro sensor 20B, for detecting a user's hand shake, are provided in the camera 10. The first and second gyro-sensors 20A and 20B detect the angular velocity of yaw and the angular velocity of pitch, respectively. Note that, yaw represents a side ways movement of the camera 10 relative to the optical axis E shown in FIG. 1, whereas pitch represents a vertical movement of the camera 10 relative to the optical axis E. Herein, X, Y, and Z coordinates are defined as shown in FIG. 1. The X-axis is parallel to the width direction of the camera 10 and the Y-axis is parallel to the vertical direction of the camera 10. The Z-axis is parallel to the optical axis E, and the X-Y plans is orthogonal to the optical axis E. When the camera 10 is in a level orientation, the X-axis is parallel to the horizontal direction and the Y-axis is parallel to the vertical direction.

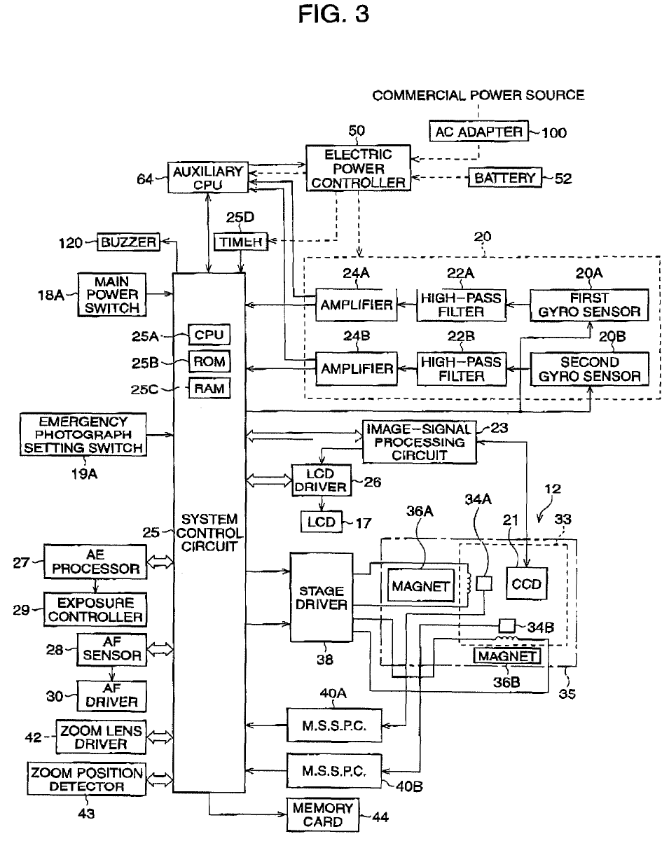

FIG. 3 is a block diagram of the camera 10. A system control circuit 25, including a CPU 25A, a ROM unit 25B, and a RAM unit 25C, controls the camera 10, and a program for controlling the camera 10 is stored in the ROM 25B. A main power switch 18A and an emergency photograph setting switch 19A are connected to the system control circuit 25. A release switch, an image-blur compensating switch, a zoom switch, and a mode setting switch (not shown) are also connected to the system control circuit 25. Each switch is turned on or off when a corresponding button, provided on the side surface 10S or back surface 10B of the camera 10, is operated by the user. When the main power button 18 is depressed and the main power switch is turned on, electric power is supplied from a battery 52 to circuits in the camera 10, and an electric power controller controls the supply of the electric power.

In the photographing mode, a signal process for displaying a moving image is carried out. Concretely speaking, light reflected from a target subject passes through the photographing optical system, and reaches the CCD 21 via a lens shutter (not shown). Namely, a subject image is formed on the light-receiving surface of the CCD 21 which has a color filter. In the CCD 21, analog image-pixel signals corresponding to the subject image are generated. The generated image-pixel signals are successively read from the CCD 21 by a CCD driver (not shown) at given constant intervals (for example, 1/60^{th}-second intervals). The read image-pixel signals are amplified and converted to digital image signals.

The digital image signals are input to an image-signal processing circuit 23, in which various processes, including a white-balance adjustment process and a gamma-correction process, are performed on the digital image signals. The processed image signals are temporarily stored in a frame memory (not shown), and are then fed to an LCD driver 26. The LCD driver 26 drives the LCD monitor 17 on the basis of the image signals, so that a moving image is displayed on the LCD monitor 17.

An AE processor detects the brightness of a target subject on the basis of the image signals. In the image-signal processing circuit 23, the brightness of the moving image is adjusted on the basis the detected brightness. Also, the AE processor calculates an exposure value according to a setting input by the user. When the zoom button is operated by the user, a control signal is sent from the system control circuit 25 to a zoom lens driver 42. Then, the zoom lens driver 42 outputs a driving signal on the basis of the control signal. The focal length is adjusted by the shifting of the zoom lens, and the zoom position detector 43 detects the focal length from the position of the zoom lens.

When the release button 13 is depressed halfway, the distance from the subject to the camera 10 is detected by an AF sensor 28, and the auto-focusing process is performed by shifting a focusing lens which is included in the photographing optical system. The focusing lens is driven by an AF driver 30 such that the image-forming surface coincides with the light-receiving surface of the CCD 21.

When the release button 15 is depressed fully, a photographing process for recording a still image is carried out. Namely, the lens shutter opens by a given amount on the basis of the calculated exposure value, thus, generating one frame's worth of image-pixel signals corresponding to a still image in the CCD 21. An exposure controller (not shown) controls the lens shutter. The generated image-pixel signals are read from the CCD 21, and are subjected to processing in the image-signal processing circuit 23. Then, the generated image data is compressed in the system control circuit 25, and the compressed image data is stored on a memory card 46 via a card driver (not shown). On the other hand, when the moving image mode is selected using the mode-setting button 14, a sequence of image-pixel signals is successively read from the CCD 21, and processed so that moving image data is recorded on the memory card 44.

When the image-blur compensating button 16 is depressed, the system control circuit 25 detects the ON status of the image-blur compensating switch. A camera-shake detector 20 has high-pass filters 22A and 22B, and amplifiers 24A and 24B, as well as the first and second gyro-sensors 20A and 20B. The camera-shake detector 20 detects angular velocities as voltage values when the posture of the camera 10 changes, namely, when it shakes.

The image-blur compensating mechanism 12 has a rectangular shift stage 33 and a rectangular fixed stage 35 opposite the shift stage 33, a stage drive 38, and a holding member (not shown) for holding the fixed stage 35 to the camera body. The CCD 21 is mounted at the approximate center of the shift stage 33. On the other hand, the fixed stage 35 has a rectangular aperture, which admits light from the photographing optical system.

The shift-stage 33 is capable of moving in the X and Y axes independently, by a coil (not shown), and moves relative to the fixed stage 35 while the image-blur compensating mechanism 12 functions. The size of the aperture formed in the fixed stage 35 is defined by the shifting-range of the CCD 21.

The system control circuit 25 calculates a displacement angle relative to the X-axis and Y-axis on the basis of the detected angular velocities, and adjusts the position of the shift stage 33 by controlling the stage driver 38. Specially, when the posture of the camera 10 changes due to the shake, the first gyro sensor 20A outputs a voltage signal corresponding to the angular velocity of the yaw, and the second gyro sensor 20B outputs a voltage signal corresponding to the angular velocity of the pitch. The DC components in these voltage signals are eliminated in the high-pass filters 22A and 22B, respectively, and amplified in the amplifiers 24A and 24B, respectively.

The system control circuit 25 detects displacement angles with respect to the X and Y-axis on the basis of the voltage signals. Then, the system control circuit 25 outputs a control signal to the stage driver 38 so as to compensate for the shake of the camera 10. Consequently the shift-stage 33 move in the X-axis and Y-axis by a driving signal output from the stage driver 38. Thus, a subject image is formed on the CCD 21 while the position of the CCD 21 shifts, and a high-quality image without an image-blur is obtained.

Magnetic sensors 34A and 34B, each composed of a device such as a Hall-Effect device, are provided around the CCD 21, and arranged along the X- and Y-axes, respectively. On the other hand, magnets 36A and 36B are arranged along the X- and Y-axes on the fixed-stage 35, respectively, and are opposite the magnetic sensors 34A and 34B, respectively. When the shift-stage 33 moves in response to the camera's shake, the magnetic sensors 34A and 34B detect a change of the magnetic field due to the position change of the magnetic sensors 34A and 34B relative to the magnets 36A and 36B. Magnetic-sensor signal-processing circuits 40A and 40B detect movement distance of the shift-stage 33 along the X-axis and Y-axis on the basis of the change of the magnetic field. The system control circuit 25 carries out feed back control of the shift-stage 33 on the basis of a difference between the present position and a calculated position.

An auxiliary CPU 64 is capable of acting while the main power source is In the OFF state, and detects an operation of the main power button 18 and the emergency photograph setting button 19, via the system control circuit 25. Also, the auxiliary CPU 64 is capable of detecting voltage signals from the amplifiers 24A and 24B in the camera-shake detector 20. The electric power controller 50, which supplies electric power from the battery 52 to the circuits, supplies electric power to the camera-shake detector 20 and the auxiliary CPU 64 on the condition that the AC adapter 100 is connected to the camera 10. A buzzer 120, connected to the system control circuit 25, sounds an alarm when an emergency photographing process is carried out. A timer 25D, connected to the system control circuit 25, measures real time. Electric power is supplied to the timer 25D while the main power source is in the OFF state.

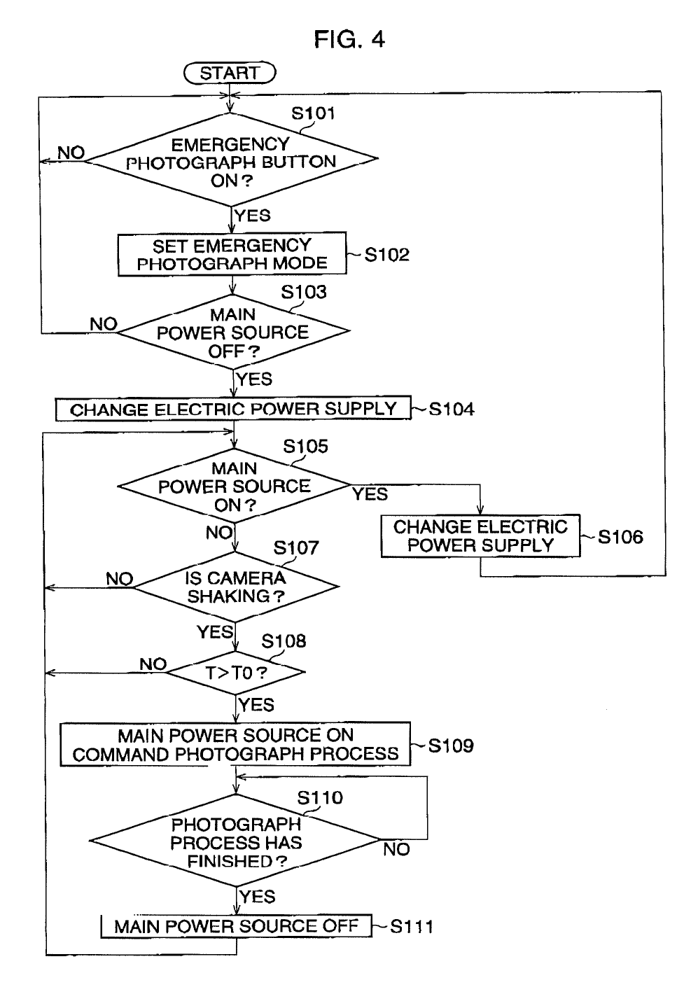

FIG. 4 is a view showing a flowchart of the electric power control process performed by the auxiliary CPU 64. Herein, the AC adapter 100 is connected to the camera 10 while the electric power source is in the OFF state.

In Step S101, it is determined whether the emergency photograph setting button 19 is depressed by the user while the main electric power source is in the ON state. If it is determined that the emergency photograph setting button 19 is depressed by the user, the process goes to Step S102, in which the emergency photograph mode is set. Thus, while the electric power source is in the OFF state, the electric power controller 50 supplies electric power to the auxiliary CPU 64, the timer 25D, and the camera-shake detector 20.

In Step S103, it is determined whether the main power button 18 has not been operated by the user to turn the main electric power source off. If it is determined that the main power button 18 has been operated by the user, the process returns to Step S101. On the other hand, if it is determined that the main power button 18 is operated by the user, the process goes to Step S104. In Step S104, the electric power supply is switched such that the main power source is turned off. Thus, electric power is not supplied to most circuits and the operation of the system control circuit 25 stops. During the main power source OFF state, the electric power 50 supplies electric power to the auxiliary CPU 64, the camera-shake detector 20 and the timer 25D.

In Step 5105, it is determined whether the main power button 18 has been operated by the user to turn the main electric power source on. If it is determined that the main power button 18 has been turned on by the user, the process goes to Step S106, in which the electric power supply is switched so that the main power source is turned on. After Step S106 is performed, the process returns to Step S101. On the other hand, if it is determined that the main power button 18 has not been operated by the user, the process goes to Step S107.

In Step S107, it is determined whether a detecting signal of the shake is sent from the camera-shake detector 20. When the camera 10 on the table shakes because of an emergency situation such as an earthquake, the camera-shake detector 20 detects the camera-shake. If it is determined that the detecting signal is not sent from the camera-shake detector 20, the process returns to Step S104. On the other hand, if it is determined that the detection signal has been sent from the camera-shake detector 20, the process goes to Step S108.

In Step S108, it is determined whether the detected shake exceeds a standard shake. Specially, it is determined whether the detected displacement angle T of either the yaw or pitch is larger than a given standard angle T0. Thus, a photographing process is not carried out when a shake is slight, i.e., when it is not necessary to photograph the scene. Herein, the standard displacement angle T0 is set to a value corresponding to the intensity of 3 on Japanese seven-stage seismic scale. Note that, the standard displacement angle T0 may be determined in accordance with the Magnitude of 6 or 6.

If it is determined at Step S108 that the shake does not exceed the standard shake, the process returns to Step S104. On the other hand, if it is determined that the shake exceeds the standard angle T0, the process goes to Step S109. In Step S109, the auxiliary CPU 64 outputs a control signal to the electric power controller 50 to turn the main power source on, namely, to supply electric power to all of the circuits. Further, the auxiliary CPU 64 outputs a command for carrying out an emergency photographing process to the system control circuit 25. Also, data associated with the detected displacement angle is transmitted from the auxiliary CPU 64 to the system control circuit 25.

In Step S110, it is determined whether a signal indicating the end of the photographing process is sent from the system control circuit 25. When it is determined that the emergency photographing process has ended, the process goes to Step S109, in which the auxiliary CPU 64 controls the electric power controller 55 so as to turn the main power source off. Thus, the waste of electricity is prevented.

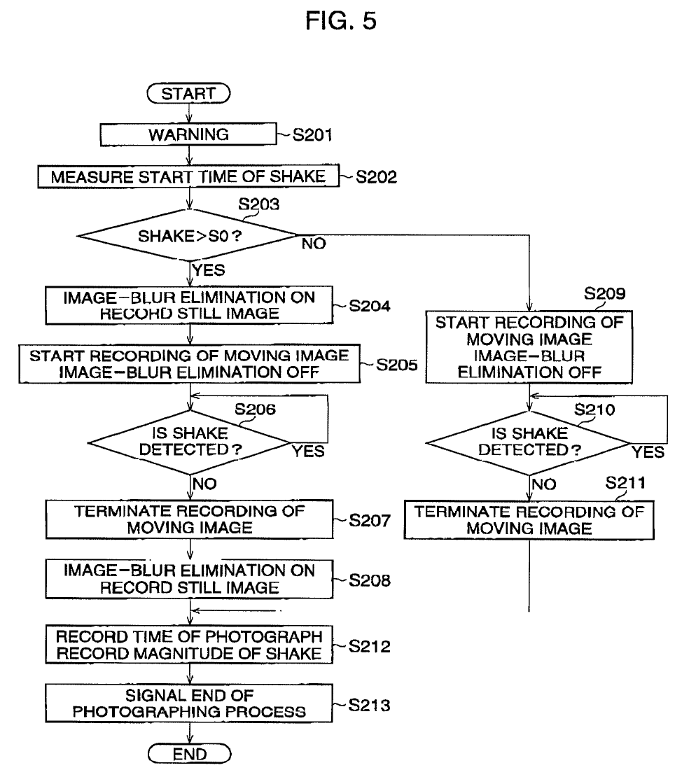

FIG. 5 is a view showing a flowchart of an emergency photographing process performed by the system control circuit 25. When a command for carrying out a photograph process for emergency is sent from the auxiliary CPU 64, the process begins.

In Step 201, a warning buzzer is sounded. In Step S102, a measurement of the time is taken in order to measure the start time of the shake. In Step S203, based on the data associated with the displacement angle of the camera 10, it is determined whether the shake exceeds a threshold shake value S0. Specifically, it is determined whether the displacement angle exceeds a threshold angle. Herein, in order to record a still image without an image-blur, it is determined whether the image-blur compensating mechanism 12 should operate on the basis of the magnitude of the shake. The threshold shake value S0 is the value necessary for carrying out the photographing process using the image-blur compensating mechanism 12. Note that, the system control circuit 25 detects the attitude of the shake while the emergency photographing process continues.

When it is determined at Step S203 that the shake exceeds the threshold shake value S0, the process goes to step S204. In Step S204, the system control circuit 25 outputs a control signal to the stage driver 38 so as to enable the image-blur compensating mechanism 12. Then, a photographing process for recording a still image is carried out. Thus, a still image without image blur is recorded on the memory card 44. In Step S205, the stage driver 38 is controlled so as not to enable the image-blur compensating mechanism 12, and a photographing process for recording a moving image is started. Thus, moving image data which shown the actual shaking situation, is continuously recorded on the memory card 44.

In Step S206, based on the detection signal fed from the camera-shake detector 20, it is determined whether the shake has ceased, or in other words, the shake has converged. Specifically, it is determined whether the detected displacement angles of the yaw and the pitch are smaller than given angles. The process or Step S206 is repeatedly carried out until the shake converges. While the shake continues, the recording of the moving image data continues. Thus, only an image representing a shake situation is recorded.

If it is determined at Step S206 that the shake has converged, the process goes to Step S207, in which the recording of the moving image data is terminated. Then, in Step S208, the stage driver 38 is controlled so as to enable the image-blur compensating mechanism 12, and the photographing process for recording a still image is carried out. After the still image is recorded, the process moves to step S212.

On the other hand, if it is determined at Step S203 that the shake does not exceed the threshold shake S0, the process goes to Step S209. The processes of Steps S209 to S211 are the same as those of Step S205 to S207, namely, the moving image data is recorded until the shake converges. Herein, since the shake is not as large as the displacement in a target scene following a disaster, a still image is not recorded. After step S211 is carried out, the process goes to Step S212.

In Step S212, the photographing period over which a series of still and moving images was recorded is determined from the basis of the current real time detected by the timer 25D and the previously detected recording start time. The photographing period is recorded as data in the RAM 25C and on the memory card 44. Also, based on the detected shake, an amplitude of maximum shake during the photographing process is recorded in the RAM 25C and on the memory card 44. Thus, data associated with the disaster situation is recorded in addition to an image. In Step S213, in order to turn the main power source off again, data signaling the end of the photographing process is transmitted to the auxiliary CPU 64.

Thus, in the present embodiment, the camera 10 with the camera-shake detector 20 and the image-blur compensating mechanism 12 is placed on a table. When the emergency photograph setting button 19 is depressed, electric power is supplied to the auxiliary CPU 64 and the camera-shake detector 20, and the camera-shake detector 20 detects a shake while the main power source is in the OFF state. Then, when a shake is detected by the occurrence of an emergency situation such as an earthquake, the main power source is turned on, and the photographing process, namely, a process for recording two still images and a moving image is carried out. Thus, the scene just after the shake occurs is recorded clearly as a still image, and the situation during some time after the shake begins is continuously recorded as a moving image. Finally, a still image is recorded to clearly record the change in the scene for comparison with the first photographed still image. After the photographing process is carried out, the main power source is turned off again.

By utilizing the consumer camera 10 with shake detecting function and image-blur compensation, a disaster situation can be photographed without preparing an exclusive camera. Furthermore, the mobile camera 10 can be placed on anywhere. Therefore, when a disaster such as an earthquake occurs, the actual image seen by witnesses, namely, the “scoop image”, can be obtained. Also, since the emergency photograph setting button 19 is provided, the photographing process is only carried out when the user wishes to photograph an emergency situation.

The system control circuit 25 may control electric power during the main power source OFF state instead of the auxiliary CPU 64. Conversely, the auxiliary CPU 64 may carry out the emergency photographing process instead of the system control circuit 25. Also, the battery 52 may supply electric power during the main power source OFF state without the AC adapter. Moreover, the camera 10 may be mounted on a cradle for battery charging while the main power source is in the OFF state. The auxiliary CPU 64 may detect the depression of the emergency photograph setting button 19 while the main power source is in the OFF state.

The emergency photographing process may always be carried out even if the camera shake is minor. During the recording of a moving image, the image-blur compensating mechanism 12 may operate. In addition, a still image may be recorded even when the camera-shake does not exceed the threshold shake.

The recording mode of the emergency photographing process may optionally be selected. For example, the user may opt to record only a still image or a moving image. Also, a still image may be recorded intermittently, or a moving image may be recorded for a predetermined period. Alternatively, only a single still image may be recorded.

As for the type of camera, a mobile camera, such as a film camera or camcorder with image-blur compensation, may optionally be used. Furthermore, an exclusive camera arranged in a specific position for monitoring may be applied. In this case, only a camera-shake detector may be provided without an image-blur compensating mechanism, and it may function only while the main power source is in the OFF state. When using a camera to which commercial electric power is always supplied, the camera may detect a shake in a sleep mode.

As for the detection of the shake, the shake detector may detect the angular velocity of the movement along other orientation other than the yaw and the pitch. Further, a camera shake may be detected without a gyro sensor. For example, the camera shake may be detected by the movement-vector of a captured image. In this case, electric power is supplied to an image signal processing circuit while the main power source is in the OFF state. The camera's shake may be detected through both of the yaw and pitch. The degree of shake may be measured by means other than angular velocity. The standard shake and the threshold shake may be determined in accordance with the specification of the camera 10.

As for the image-blur compensation, other mechanisms may be applied For example, an optical lens may be shifted instead of the CCD, or the shutter speed may be adjusted in accordance with the shake.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2006-315487 (filed on Nov. 22, 2006), which is expressly incorporated herein by reference, in its entirety.

1. A camera comprising:
a shake detector configured to be capable of detecting a shake while a main power source is in the OFF state;
a main power-source controller that turns the main power source from OFF to ON when a shake is detected while the main power source is in the OFF state; and
a photograph controller configured to carry out a photographing process when the main power source is turned on by the detection of the shake.

2. The camera of claim 1, wherein the shake detector comprises a hand-shake detector that detects a movement of the camera due to an operator's hand shake.

3. The camera of claim 1, further comprising an emergency photograph setting member that is operated to carry out the photographing process in the main power source OFF state, said electric power controller supplying electric power to said shake detector during the main power source OFF state when the emergency photograph setting member is operated.

4. The camera of claim 1, wherein said electric power controller turns the main power source off when the photographing process based on the detection of the shake is terminated.

5. The camera of claim 1, wherein said photograph controller comprises a first determiner that determines whether the shake is larger than a standard shake, said photograph controller carrying out the photographing process when the shake is larger than the standard shake.

6. The camera of claim 1, wherein said photograph controller records a still image first, and then records a moving image.

7. The camera of claim 6, wherein said photograph controller records a still image after recording a moving image.

8. The camera or claim 1, further comprising a second determiner that determines whether the shake has converged, said photograph controller terminating the photographing process when the shake has converged.

9. The camera of claim 1r further comprising an image-blur compensating device configured to prevent an image-blur due to the shake, said photograph controller being capable of controlling the operation of said image-blur compensating device when carrying out the photographing process.

10. The camera of claim 9, wherein said photograph controller records a moving image without the use of said image-blur compensating device.

11. The camera of claim 9, further comprising a third determiner that determines whether the shake exceeds a threshold shake, said photograph controller recording a still image while operating said image-blur compensating device when the shake exceeds the threshold shake.

12. The camera of claim 11, wherein said photograph controlled records only a moving image when the camera shake does not exceed the threshold shake.

13. The camera of claim 1, further comprising a shake period detector that detects the duration of the camera-shake.

14. The camera of claim 1, further comprising a shake degree detector that detects the degree of the shake.

15. An apparatus for photographing a subject comprising:
a shake detector configured to detect a shake while a photographing process is not carried out; and
a photograph controller configured to carry out a photographing process for recording at least one of a still image and a moving image when a shake is detected.

16. A computer-readable medium that stores a program for photographing a subject, comprising:
a shake-detection code segment that detects whether a shake occurs while a photographing process is not carried out; and
a photograph control code segment that carries out a photographing process for recording at least one of a still image and a moving image when a shake is detected.

17. A method for photographing a subject comprising;
detecting whether a shake occurs while a photographing process is not carried out; and
carrying out a photographing process for recording at least one of a still image and a moving image when a shake is detected.
